(19) United States
(12) Patent Application Publication
(10) Pub. No.: US 2008/0078708 A1
(43) Pub. Date: Apr. 3, 2008

(54) Device for Orienting Flat Items of Mail Towards a Narrow Edge

(75) Inventors: Holger Schererz, Rehfelde (DE); Andre Tolksdorf, Berlin (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/792,799

(22) PCT Filed: Nov. 18, 2005
(86) PCT No.: PCT/EP05/12359

§ 371 Date: Sep. 24, 2007

(30) Foreign Application Priority Data
Dec. 11, 2004 (DE) 10 2004 059 865.7

(51) Int. Cl. B07C 5/06

(52) U.S. Cl. 209/658

(57) ABSTRACT

A device for orienting flat mail items with a u-shaped conveying channel has a base belt guided over reversing rollers and driven at a predetermined speed. First and second guiding belts are driven at the predetermined speed and guided over deflection rollers. A flat mail item is transported over a defined path standing on its narrow side. The first guiding belt is inclined as a lateral reference belt for frictional orientation of the mail items and guided via fixed deflection rollers. The second guiding belt is guided by pression deflection rollers so that the conveying channel possesses a defined minimum channel width to orient thin mail items on the base belt. For the mail items located in the conveying channel, the second guiding belt deviates against a spring force of a deflection roller bearing, with the second guiding belt possessing a lower coefficient of friction than the lateral reference belt.

The invention relates to a device for orienting flat mail items towards a narrow side as claimed in the preamble of claim 1.

Stacks of mail items are automatically separated in the entry section of mail item sorting machines by the furthest forward mail item being drawn off in each case. The individual mail items are then transported in turn in an upright position to process devices such as address readers and printers. In such cases the mail items may not be twisted nor offset in height at the process devices. Since however this is often the case after separation, the mail items pass through an orientation path after the separation process.

Patents GB 921 679 and DE 195 28 829 C2 describe orientation paths in which the mail items are forcibly guided in an upright position, with the orientation being undertaken by rollers or belts positioned at an angle against which the mail items are pressed.

In DE 1 116 602 A, DE 37 09 659 C2 and FR 2 692 565 A1 the orientation path consists of an open unshaped conveying channel, in which the mail items are transported upright without pressure from the sides. Here the mail items are oriented when passing through the orientation path by their gravity onto their lower narrow side (bottom edge). To support the orientation, especially with static loading, at least one lateral guiding belt of the orientation path is inclined towards the base belt. The orientation path in this case is designed for a restricted spectrum of items with regard to thickness, i.e. either for letters and cards or large mail items, periodicals etc. If a large range of thicknesses is to be processed however, i.e. both thin mail items and also magazines or periodicals, the spacing of the lateral delimiters of the transport channel must be designed for the maximum mail item thickness.

Thin letters with low inherent stiffness can then however, on passing through the significantly wider conveying channel at least partly collapse into themselves. On transfer onto the subsequent transport path to the process devices there is then no orientation, which can result in transport faults, damage to the mail items and read errors. A further method and a device for orientation of flat mail items was known (DE 103 19 723 B3), in which, to avoid these described disadvantages, in a unshaped conveying channel the channel width is expensively actively adapted for orientation to the respective mail item thickness in accordance with the measured mail item thicknesses by means of an adjustment mechanism.

An orientation path was also known in which the flat mail items are orientated in a lying position by friction force by means of inclined belts on one edge without the effects of the force of gravity (JP 2000-118 805 A).

The object of the invention is to create a device for orienting flat mail items towards a narrow side with a u-shaped conveying channel, in which the mail items are transported standing on a narrow side, with which both thick and also thin mail items with little rigidity can be oriented with little effort, without the thin, soft mail items collapsing into themselves.

In accordance with the invention the object is achieved by the features of claim 1.

In this case a lateral guiding belt inclined in the direction of transport as a reference belt, on which the mail items are transported oriented in the conveying channel, is guided via local fixed deflection rollers. The other guidance belt is guided by means of resiliently received pression deflection rollers in such a manner that the conveying channel has a defined minimum channel width. For mail items located in the conveying channel which are thicker than the minimum channel width, the other guiding belt deviates outwards in accordance with the corresponding width of the respective mail item against the spring force of the deflection roller bearing, with the other guiding belt having a smaller coefficient of friction than the lateral reference belt. For mail items with a thickness greater than the minimum channel width the channel width is thereby adapted passively to the thickness of the items. In such cases those mail items are pressed against the lateral reference belt and oriented frictionally via its gradient to the basic belt, which is additionally supported by the higher gravitational force of the thicker mail items.

Thin mail items are oriented with the aid of their gravitational force to the base belt. The gravitational force in conjunction with the inclined position of the lateral reference belt implements the orientation process of these thin mail items.

In the typical case in which, in the upstream process of separation, thin items can be electrostatically charged and then adhere to the lateral reference belt if necessary, a sufficient orientation function is thus implemented via the gradient of the lateral reference belt.

Advantageous embodiments of the invention are set down in the subclaims.

To reduce the stress on the pression deflection rollers with the guiding belt from the incoming and outgoing mail items, guiding rails absorbing shocks of the mail items with a small coefficient of friction in relation to the mail items are advantageously attached on the holders of the pression deflection rollers running at an angle to the direction of transport and tangentially to the pression deflection rollers.

It is also advantageous in the entry area to guide and deflect the other guiding belt via three deflection rollers arranged at the apexes of a pivotable triangle. The pression deflection roller and the rear deflection rollers are supported to allow them to pivot on rotatably attached lever arms at a pivot point at which the third deflection roller furthest forward in the direction of transport is attached, with the deflection roller bearing pressing against a stop ensuring the minimum channel width and with the pression deflection roller with the other guiding belt being pushed by an incoming mail item in accordance with the thickness of the item away from the stop against a force which is created by the corresponding deflection of the other guiding belt in accordance with the belt tension and the belt elasticity.

For the exit area it is advantageous to guide the other guiding belt back over a further pression deflection roller and via rear deflection roller of the exit area, with these two deflection rollers each being rotatably supported on a lever arm. The two lever arms are attached with their other ends at a pivot point and are attached diverging from this point, which is located in the direction of transport in front of the two deflection rollers almost centrally between them, with the deflection roller bearing of the exit area pressing against a further stop which ensures the minimum channel width. The pression deflection roller of the exit area with the other guiding belt is pushed by an outgoing mail item in accordance with the thickness of the item away from the stop against a force which is created by the corresponding deflection of the other guiding belt running over the rear deflection roller against a tension roller of the exit area.

To reduce the shock stresses on the mail items and the pression belt mechanisms it is advantageous to attach the guide rails to the lever arms of the pression rollers of the pression belt by means of vibration-damping elements.

It is also advantageous to provide the base belt on the transport side with a high coefficient of friction in relation to the mail items, which prevents a lateral relative displacement of the bottom edge of the mail item from the base belt and thus additionally counters a rolling together of the mail items in the lower area.

The invention is explained in greater detail below in an exemplary embodiment with reference to the drawings.

The figures show

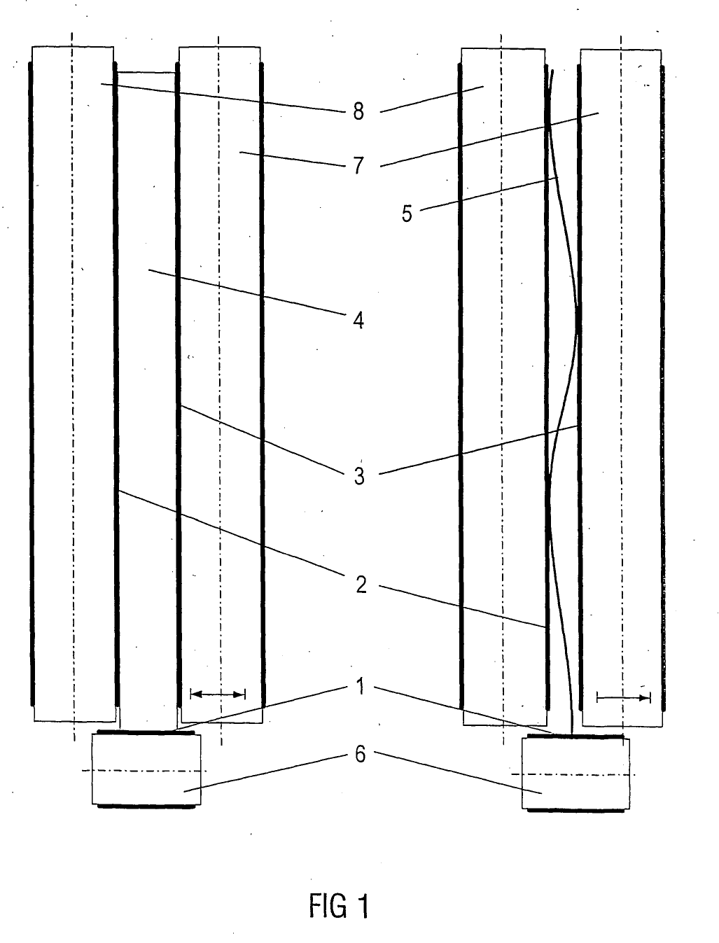

FIG. 1 a schematic cross-sectional diagram of the exit area of the orientation device,

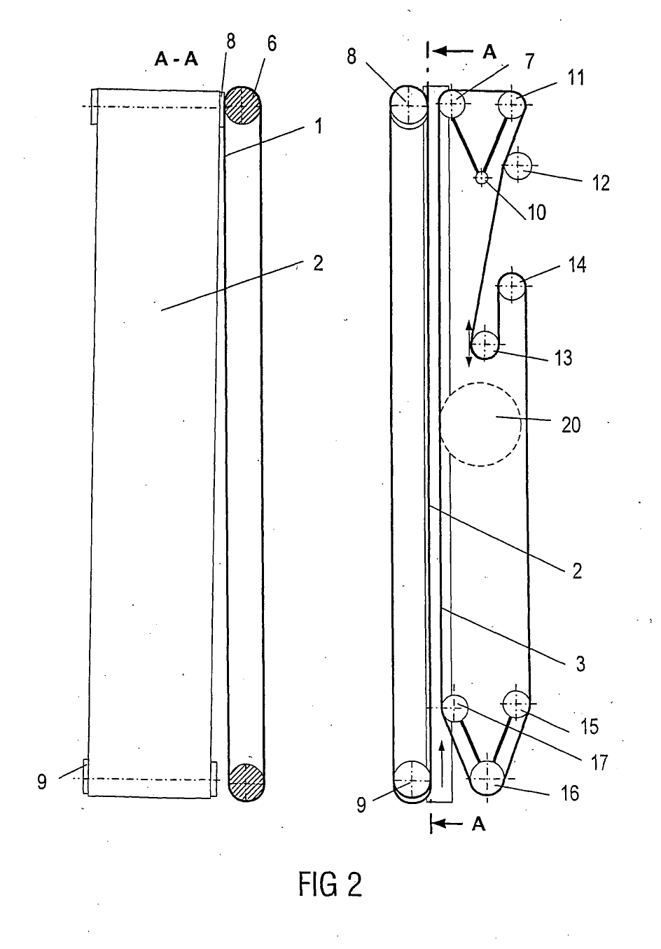

FIG. 2 a schematic overhead view and an associated cross-sectional diagram of the orientation device,

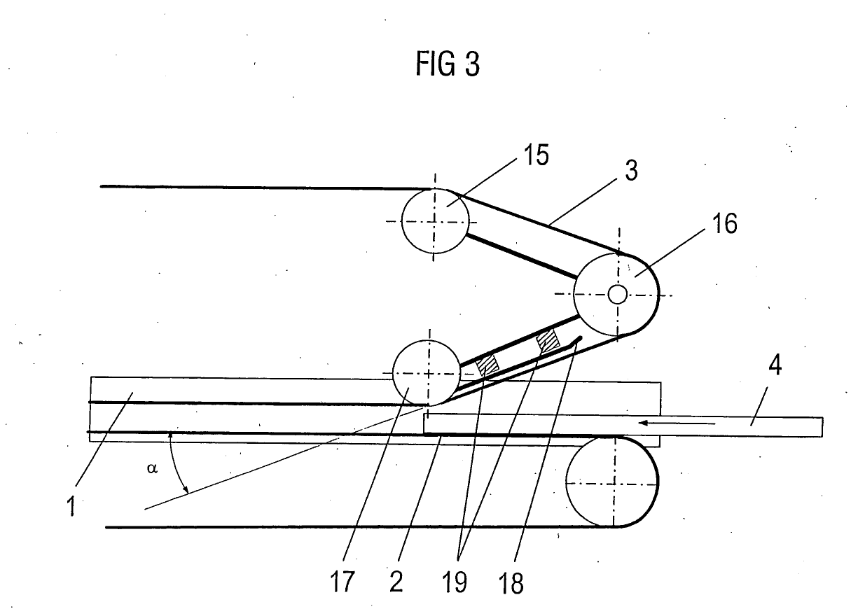

FIG. 3 an overhead view of the entry area of the orientation device,

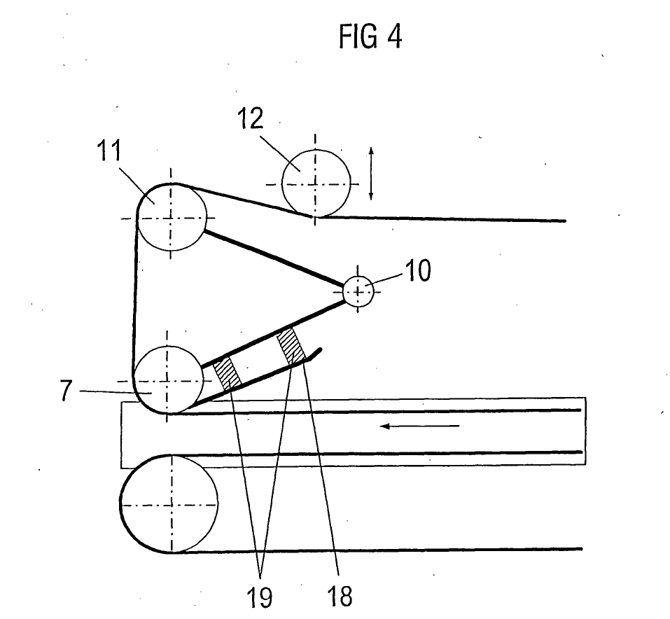

FIG. 4 an overhead view of the exit area of the orientation device.

The orientation device consists in accordance with FIG. 1 of a u-shaped conveying channel with a driven, endless horizontally-oriented base belt 1 guided via deflection rollers and two endless, vertically-oriented lateral guiding belts 2, 3 driven at the same speed. In this case one guiding belt is guided as lateral reference belt 2 via local fixed deflection rollers 8, 9, with the deflection rollers 8, 9 being oriented so that the lateral reference belt 2 is inclined in the direction of transport. The other guiding belt 3, when the conveying channel is empty, has a defined minimum spacing from the lateral reference belt 2 which guarantees that thin bendable mail items 5 are not jammed but can also not collapse. The other guiding belt 3 is arranged by a specific combination of motion links 7, 10, 11 and 15, 16, 17 at the entry and exit to allow it to passively deflect-thicker mail items 4 without any negative affect (transport slippage) and in doing so, to orient these items to the second guiding belt 2. The length of the orientation device and the selected gap between the mail items is exclusively determined by the necessary function, i.e. with consecutive maximum-thickness and thinnest mail items the support function for the thin mail items and the orientation towards the lower edge must be guaranteed. To ensure the support function of the other guiding belt 3, a foam roller 20 can be provided to support the guiding belt 3 for a relatively long orientation device. So that all mail items, both the thin mail items which may adhere to the lateral reference belt 2 because of static charges, and also the thicker mail items which are easily jammed between the two guide belts, are safely oriented, the lateral reference belt 2 is inclined in the direction of transport, in which case it is provided with a high coefficient of friction. The other guiding belt 3 on the other hand has a low coefficient of friction, so that the orientation process is not adversely affected.

At the entry of the orientation device, in accordance with FIG. 2 and FIG. 3, there is a motion link, consisting of three deflection rollers 15, 16, 17 arranged at the apexes of a pivotable triangle over which the other guiding belt 3 is routed and deflected. Pression roller 17 and the rear deflection roller 15 are each rotatably supported on a pivotably attached lever arm at a pivot point at which the third deflection roller located furthest forward in the direction of transport is rotatably attached. Guide rails 18 are attached by means of vibration-damping elements 19 to the lever arm of pression deflection roller 13. This means that especially for thick mail items 4 with a low inherent damping (high level of hardness) the opening shock of the motion link is damped. The pression deflection roller 17 with the guiding belt 3 and the guide rails 18 is pressed by an incoming mail item 4 according to the thickness of the item outwards against a force. This adjustable force is solely created by the corresponding deflection of the other, elastically-embodied guiding belt 3 without an additional spring element. The entry motion link exhibits a low moment of mass inertia in the sense of a low transport slippage and a possible small pressure on the mail item 4. The triangular form guarantees that the angle of entry (α) and thereby the difference between the speed components of the other guiding belt 3 in the direction of transport are kept low. The coefficients of friction of the guiding belt 3 guided over the guide rails 18 are to be selected so as to be small on both sides since, when thick incoming mail items 4 occur, the friction between guiding belt 3 and guide rails 18 is briefly applied as additional power into the guiding belt 3. On the transport side a low friction for mail item 4 is required, since the speed of the incoming mail item 4, depending on the angle α, is greater than that of the guiding belt 3 running at the angle α. The result, in the entry phase, is thus a relative movement between mail item 4 and guiding belt 3.

In order not to convert this relative movement into a transport slippage, the lateral reference belt 2 on the transport side and the base belt 1 are provided with a high coefficient of friction in relation to the mail items 4, 5. The spring force of this entry motion link and of the exit motion link is defined by means of the belt tension, which is adjusted by the displaceable roller 13 and the fixed opposing roller 14, which also serves as a drive roller, the selected belt elasticity and the roller 12 adjustable at right angles to the direction of transport.

The exit motion link (FIG. 4), in a similar manner to the entry motion link, has a pivot point 10 at which two diverging lever arms are attached, a further pression roller 17 and a rear deflection roller 11 of the exit area, which are both attached rotatably to the free ends of the lever arm. A guide rail 18 is also attached to the lever arm of the pression roller 17 by means of damping elements 19.

1. A device for orienting flat mail items towards a narrow side with a u-shaped conveying channel, comprising:
an endless horizontally-oriented base belt guided over reversing rollers and driven at a predetermined speed;
first and second endless lateral guiding belts driven at the predetermined speed ad guided over deflection rollers wherein a flat mail item of a stream of mail items is transported over a defined path standing on its narrow side, wherein the first lateral guiding belt, on which the mail items are transported oriented in the conveying channel, is inclined as a lateral reference belt for frictional orientation of the mail items with lower edges on the base belt in a direction of transport and is guided via locally fixed deflection rollers,
wherein
the second lateral guiding belt is guided by means of resiliently-supported pression deflection rollers so that
the conveying channel possesses a defined minimum channel width in order to orient thin mail items, of which a thickness is thinner than the minimum channel width, by means of a gravitational force with the lower edges on the base belt and
for the mail items located in the conveying channel which are thicker than the minimum channel width, the second lateral guiding belt in accordance with the respective mail item thickness deviates outwards against a spring force of a deflection roller bearing, with the second lateral guiding belt possessing a lower coefficient of friction than the lateral reference belt.

2. The device of claim 1, further comprising stops of guide rails accommodating the mail items, wherein the stops of guide rails are arranged to run at an angle to the direction of transport and tangential to the pression deflection rollers on holders of the pression deflection rollers with a low coefficient of friction in relation to the mail items.

3. The device of claim 1, wherein
in an entry area the second lateral guiding belt is guided and defected over three deflection rollers arranged at apexes of a pivotable triangle,
a pression deflection roller and a rear deflection roller are rotatably supported on pivotably attached lever arms at a pivot point at which a distant deflection roller located furthest forward in the direction of transport is rotatably attached,
with a deflection roller bearing pressing against a stop ensuring the minimum channel width and
with the pression deflection roller with the second lateral guiding belt being pressed by an incoming mail item, in accordance with a width of the item, away from the stop against a force which is created by a corresponding deflection of the second lateral guiding belt in accordance with a belt tension and a belt elasticity.

4. The device of claim 1, wherein, in an exit area the second lateral guiding belt is guided back over a further pression deflection roller, and over a rear deflection roller of the exit area,
with these two deflection rollers each being rotatably supported on a lever arm, and the two lever arms being attached at their other ends to a pivot point and being attached diverging from this point which is located in the direction of transport in front of the two deflection rollers and substantially centrally between them,
with the deflection roller bearing of the exit area pressing against a further stop ensuring the minimum channel width, and
with the pression deflection roller of the exit area being pushed away from the stop with the second lateral guiding belt by an outgoing mail item, in accordance with a thickness of the item, against a force which is created by the corresponding deflection of the other guiding belt of the exit area in accordance with the belt tension and the belt elasticity.

5. The device of claim 2, wherein the guide rails are attached to the lever arms of the pression deflection rollers of the second lateral guiding belt by means of vibration-damping elements.

6. The device of claim 1, wherein the base belt is provided on the transport side with a high coefficient of friction in relation to the mail items.
